(19) United States
(12) Patent Application Publication
(10) Pub. No.: US 2020/0129993 A1
(43) Pub. Date: Apr. 30, 2020

(54) Method of Separating Anion and Cation Exchange Resins and Device for the Same

(71) Applicant: Institute of Nuclear Energy Research, Atomic Energy Council, Executive Yuan, R.O.C., Taoyuan (TW)

(72) Inventors: Chun-Ping Huang, Taoyuan (TW); Hsin-Yu Chen, Taoyuan (TW)

(21) Appl. No.: 16/174,379

(22) Filed: Oct. 30, 2018

(51) Int. Cl. B03D 3/00; B01J 49/09

(52) U.S. Cl. CPC B03D 3/00; B01J 49/09

(57) ABSTRACT

A method is provided for separating anion and cation exchange resins. The specific-gravity difference between the anion and cation exchange resins is used for separation with a column body. The column body comprises an outer column and an inner column set within. The inner column has an outlet with position adjustable for outputting the anion exchange resin according to its ratio. The flow zone and the resin expansion zone can effectively shorten the time required for the separation. Besides, the required equipment is simplified. Only the size of the column body needs to be adjusted according to the amount of the mixed bed resin to-be-treated. The present invention can be applied to different proportions of mixed beds and mixed resins. On consideration of equipment cost and operating cost, the method can complete the separation of the anion and cation exchange resins in a short time with the simplified equipment.

### TECHNICAL FIELD OF THE INVENTION

The present invention relates to separating anion and cation exchange resins; more particularly, to using the different fluid heights and the different sedimentation velocities in a fluidized bed for separation according to the different specific gravities between anion and cation exchange resins, where the present invention can be used in separation for a variety of mixed bed resins having mixing proportions unfixed.

### DESCRIPTION OF THE RELATED ARTS

Mixed-bed anion-and-cation exchange resins are commonly used in various water purification processes, such as the removal of heavy metal ions. They are widely applied in boiler water, waste water treatment, laboratory ultra-pure water, and so on. Generally, used-water purification for the mixed bed resin are regeneration processes. The cation exchange resin is regenerated with hydrochloric acid; and the anion exchange resin, sodium hydroxide. A great benefit would be gained if these two regeneration can be performed separately. When the to-be-treated mixed bed resin comes from a nuclear industry, its exchanging particles are radionuclides. At the moment, if the anion and cation resins can be separated, the subsequent stabilization will be benefited.

Nuclear facilities are built world-widely. A large number of anion-and-cation mixed bed resins are used for the purification of radioactive liquid waste in the nuclear industry. However, the main radioactive isotope in water is mostly in a cationic form. For example, after cations of cobalt, iron, strontium, cesium, etc. are exchanged, they are stored in the cation exchange resin. Many documents also indicate that almost none radionuclides exist in the anion exchange resin. In general, the ratio of anion and cation exchange resins in a mixed-bed ion-exchange unit is about 3:2. Therefore, if the anion and cation exchange resins can be effectively separated in a mixed-bed ion-exchanger, the purpose of reducing the volume of radioactive waste can be achieved.

Regarding prior arts, a prior art discloses a device and method for testing the separation degree of ion exchange resins with water treatment. The anion and cation exchange resins are not taken out after being stratified in this prior art. Hence, this prior art is only applied for testing separation effect, but is not actually applied to separate the anion and cation exchange resins, whose purpose is different from that of the present invention. Another prior art discloses a separation column tower of resin for nuclear condensate polishing. This prior art has a feeding process for separated flows together with a flow condition of resin in the reactor, which are different from the present invention. Another prior art, U.S. Pat. No. 5,736,052, discloses an ion exchange resin particle separation system. This prior art uses two tanks for processing separation and, after separating resins, regeneration is processed directly by accessing a regeneration apparatus, which is different from the present invention. Another prior art discloses a new method for completely separating mixed resin. This prior art uses two fluids, air and water, for separation, whose selected flow zone is different from the present invention. Another prior art, U.S. Pat. No. 4,264,439, discloses a method for separating anion and cation exchange resins in a mixed resin bed. This prior art determines anion and cation layers by using conductivity difference, and an inert substance is added to separate the anion and cation layers, which is different from the present invention. Another prior art, U.S. Pat. No. 9,278,360B2, discloses an air-assisted separation system. This prior art uses air to assist separation with a separator having a conical shape, which is different from the present invention. Another prior art is disclosed in “Separation and treatment of ion-exchange resins used in cleaning systems of a research nuclear reactor” by R. Ma. Flores-Espinosa et al. (Chemical Engineering Journal, Vol. 188, 2012, pp. 71-76). This prior art comprises two separating columns having different designs, where both columns use a sodium chloride (NaCl) solution to help separation. One column uses the expansion-height difference of the anion and cation exchange resins of a fluidized bed to preliminary process separation and, then, a smaller tank is accessed to process separation again by settling. The other column uses a settling process to separate the anion and cation exchange resins, where regeneration is directly processed in the column. This prior art needs to design the outlet for the anion resin according to the proportions of the mixed bed resin fed in. The design cannot be changed according to different proportions of resins, so that it is less friendly for different proportions of mixed bed resin, which is obviously different from the present invention. Besides, although this prior art uses resin expansion height and settling speed for separation, a higher speed is mostly chosen for separation. Hence, when the final speed of the anion exchange resin is reached, the resin can flow out without using external force. That is to say, pneumatic transport is used in the flow zone. In the zone, the resin particles are more dispersed. Therefore, the time for separating the anion exchange resin becomes longer. In addition, the single system is mostly used for processing a mixed bed resin having a fixed proportion, not for that having a various or unknown ratio.

Since resin can be widely applied, a part of to-be-treated resins are inevitably mixed anion and cation resins having undetermined proportions. Under such conditions, the stratification of the anion and cation exchange resins cannot be predicted, nor the outlet position of the separator can be designed in advance. A separator in response to various resin proportions at any time is required. Hence, the prior arts do not fulfill all users' requests on actual use.

### SUMMARY OF THE INVENTION

The main purpose of the present invention is to hold an anion exchange resin in a fluidized bed zone by controlling a flow speed of fluid for effectively separating anion and cation exchange resins, where the required equipment is simplified; only the size of a column body needs to be adjusted according to the amount of a mixed bed resin to-be-treated; and, on consideration of equipment cost and operating cost, the present invention can complete the separation of anion and cation exchange resins in a short time with the simplified equipment.

Another purpose of the present invention is to diminish subsequent stability problem after separation, where an effective choice is provided for processing a mixed bed resin contaminated in a nuclear industry in particular for helping resin treatment and waste-volume reduction.

To achieve the above purposes, the present invention is a method of separating anion and cation exchange resins, comprising steps of: (a) obtaining a column separator apparatus to separate a mixed bed resin, where the separator apparatus comprises a column body; a solid-liquid separator connecting to the column body; and a separated-product receiver connecting to the column body and the solid-liquid separator; where the column body comprises an outer column and an inner column, and the inner column is movably set in the outer column with a height position adjustable; where the outer column has a resin inlet on top; a fluid inlet at bottom; and a first outlet on the wall of the outer column adjacent to bottom; where the inner column is a second outlet; and where the mixed bed resin is fed in from the resin inlet to process rough separation for the first time through gravitational settling; (b) inputting a fluid into the outer column from the fluid inlet at bottom of the column body to fluidize the mixed bed resin and clearly stratify anion and cation exchange resins in the mixed bed resin, where a layer of the cation exchange resin is expanded to 2˜2.5 times to original volume; a layer of the anion exchange resin is expanded to 3.8˜5.3 times to original volume; and 1˜3 centimeters of a layer of mixed resin is formed between the two layers of the anion and cation exchange resins; (c) adjusting the inner column to a position above the layer of mixed resin, where the anion exchange resin together with the fluid are sucked out from the second outlet to be inputted into the solid-liquid separator to separate the anion exchange resin from the fluid; and the fluid flows back to the column body through the fluid inlet to be recycled; and, (d) after sucking out the anion exchange resin from the column body, flowing out the cation exchange resin left in the outer column through the first outlet. Accordingly, a novel method of separating anion and cation exchange resins is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the view showing the separator apparatus;

FIG. 2 is the flow view showing the preferred embodiment according to the present invention; and

FIG. 3 is the view showing the separated exchange resins.

### DESCRIPTION OF THE PREFERRED EMBODIMENT

The following description of the preferred embodiment is provided to understand the features and the structures of the present invention.

For anion and cation exchange resins prepared with polystyrene and divinyl benzene copolymer, screen is not available for separation owing to their very similar particle sizes. However, the cation exchange resin has a proportion about 20 percent (%) greater than the anion exchange resin in a mixed resin. A process of gravity or flotation can be used for separation. Hence, the present invention uses liquid-phase fluidization to effectively separate the anion and cation exchange resins. An inner column is set with an outlet having a position adjustable at any time according to the proportions of the exchange resins to-be-treated. Thus, the present invention can be applied to various proportions of mixed beds and mixed resins.

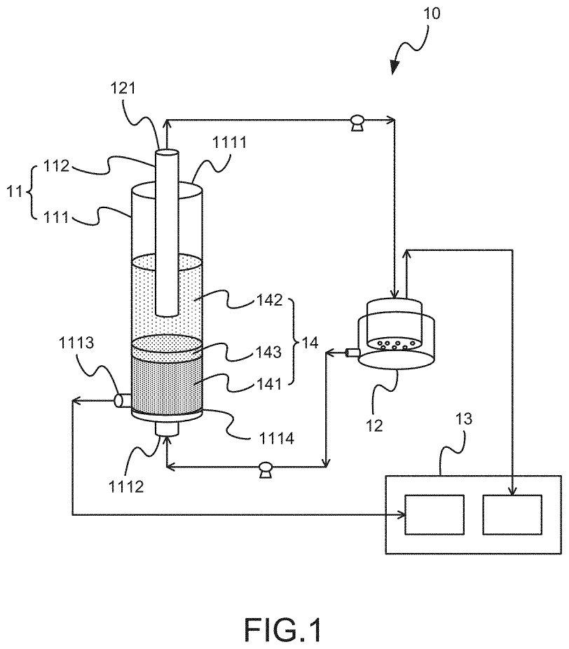

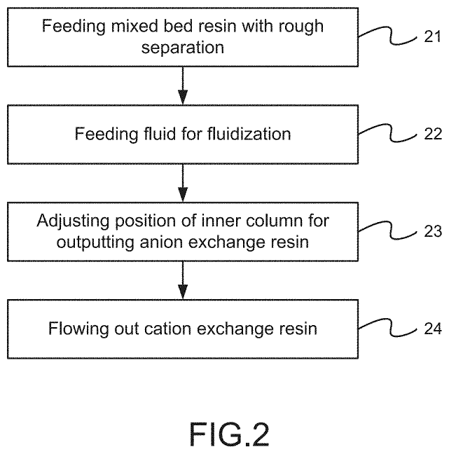

Please refer to FIG. 1 to FIG. 3, which are a view showing a separator apparatus; a flow view showing a preferred embodiment according to the present invention; and a view showing separated exchange resins. As shown in the figures, the present invention is a method of separating anion and cation exchange resins. A separator apparatus, column separator apparatus 1, is used, which comprises a column body 11; a solid-liquid separator 1112 connecting to the column body 11; and a separated-product receiver 13 connecting to the column body 11 and the solid-liquid separator 1112. The column body 11 comprises an outer column 111 and an inner column 1112, where the inner column 1112 is movably set in the outer column 111 with a height position adjustable. The outer column 111 has a resin inlet 1111 set on top; a fluid inlet 1112 set at bottom; and a first outlet 1113 set on the wall adjacent to bottom for outputting a separated product. A filter 1114 is further set at bottom of the outer column 111. The inner column 1112 with the height position adjustable is used as a second outlet 1121 for outputting another separated product along with a fluid.

For a general mixed bed resin, the cation exchange resin usually occupies 30˜40% in volume; and the anion exchange resin, 60˜70%. By using the column body 11 having a volume about 2 liters, an inner diameter of 6 centimeters (cm) and a length of 80 cm, approximate 200˜250 grams of the mixed bed resin can be processed.

On using, the present invention further comprises a pretreatment of mixed bed resin to fully stir the mixed bed resin for reducing the agglomeration of resin. The present invention comprises the following steps:

(a) Feeding mixed bed resin with rough separation s101: The column separator apparatus 1 is used to separate a mixed bed resin 14. The mixed bed resin 14 is fed in from the resin inlet 1111 on top of the column body for rough separation for the first time through gravitational settling.

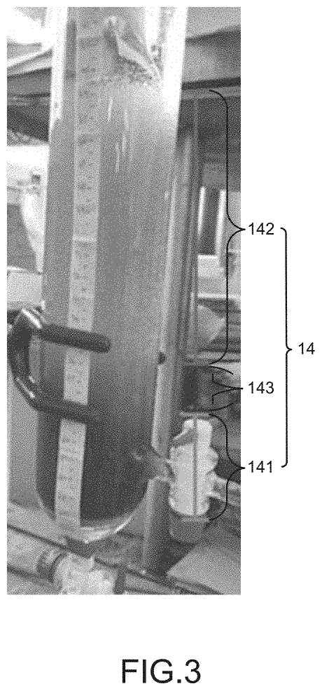

(b) Feeding fluid for fluidization s102: A fluid (e.g. water) is fed into the outer column 111 from the fluid inlet 1112 at bottom of the column body 11 in a flow speed of 20˜45 cm per minute; and anion and cation exchange resins 142,141 in the mixed bed resin 14 are clearly stratified. Therein, a layer of the cation exchange resin 141 is expanded to 2˜2.5 times to original volume; a layer of the anion exchange resin 142 is expanded to 3.8˜5.3 times to original volume; and 1˜3 centimeters (cm) of a layer of mixed resin 143 is formed between the two layers of the anion and cation exchange resins 142,141, as shown in FIG. 3.

(c) Adjusting position of inner column for outputting anion exchange resin s103: The inner column 1112 is adjusted to a position 1˜2 cm above the layer of mixed resin 143. The anion exchange resin 142 together with the fluid are sucked out from the second outlet 1121 to be inputted into the solid-liquid separator 1112. Therein, 80 percent of the anion exchange resin 143 is separated from the cation exchange resin 141 in a short time; the anion exchange resin 143 is separated from the fluid in the solid-liquid separator 1112; and the fluid flows back to the column body 11 through the fluid inlet 1112 to be recycled.

(d) Flowing out cation exchange resin s104: The cation exchange resin 141 left in the outer column 111 flows out through the first outlet 1113 adjacent to bottom after sucking out the anion exchange resin 142 from the column body 11.

The fluid, water, can be replaced with a solution added with a various solute according to a requirement, where the solute is an agent, like sodium hydroxide or sodium chloride, to adjust the specific gravity of the fluid to 1.10˜1.19.

The column body 11 is not limited in volume, inner diameter and length.

The present invention uses the different fluid heights in a fluidized bed and the different sedimentation velocities for separation according to the different specific gravities between the anion and cation exchange resins; and an inner column having the position of an outlet adjustable is used for a mixed bed resin having a various proportion. Thus, the present invention can be used in separations for a variety of mixed bed resins having mixing proportions unfixed. For the treatment of the mixed bed resin, the anion exchange resin is held in a fluidized bed zone by controlling the flow speed of the fluid to effectively separate the anion and cation exchange resins and shorten the time required for separation. For processing the mixed bed resin contaminated in a nuclear industry in particular, the separation can diminish subsequent stability problem by providing an effective choice of helping resin treatment and waste-volume reduction. Besides, the present invention uses a relatively simple apparatus. What is required only is to adjust the size of the column body according to the amount of the mixed bed resin to-be-treated. On considering equipment cost and operating cost, the present invention uses a relatively simple apparatus to accomplish the separation of the mixed bed resin in a short time.

To sum up, the present invention is a method of separating anion and cation exchange resins, where a flow zone and a resin expansion zone effectively shorten the time required for separation; only the size of a column body needs to be adjusted according to the amount of a mixed bed resin to-be-treated; the present invention is applied to different proportions of mixed bed resins; and, on considering equipment cost and operating cost, the present invention uses a relatively simple apparatus to accomplish the separation of the mixed bed resin in a short time.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of separating anion and cation exchange resins, comprising steps of:
(a) obtaining a column separator apparatus to separate a mixed bed resin,
wherein said separator apparatus comprises a column body; a solid-liquid separator connecting to said column body; and a separated-product receiver connecting to said column body and said solid-liquid separator;
wherein said column body comprises an outer column and an inner column, said inner column being movably disposed in said outer column with a height position adjustable;
wherein said outer column has a resin inlet on top; a fluid inlet at bottom; and a first outlet on the wall of said outer column adjacent to bottom;
wherein said inner column is a second outlet; and
wherein said mixed bed resin is fed in from said resin inlet to process rough separation for the first time through gravitational settling;
(b) inputting a fluid into said outer column from said fluid inlet at bottom of said column body to fluidize said mixed bed resin and clearly stratify anion and cation exchange resins in said mixed bed resin,
wherein a layer of said cation exchange resin is expanded to 2˜2.5 times to original volume; a layer of said anion exchange resin is expanded to 3.8˜5.3 times to original volume; and 1˜3 centimeters (cm) of a layer of mixed resin is disposed between said two layers of said anion and cation exchange resins;
(c) adjusting said inner column to a position above said layer of mixed resin,
wherein said anion exchange resin together with said fluid are sucked out from said second outlet to be inputted into said solid-liquid separator to separate said anion exchange resin from said fluid; and said fluid flows back to said column body through said fluid inlet to be recycled; and
(d) after sucking out said anion exchange resin from said column body, flowing out said cation exchange resin left in said outer column through said first outlet.

2. The method according to claim 1,
wherein, before step (a), the present invention further comprises a pretreatment of mixed bed resin to fully stir said mixed bed resin.

3. The method according to claim 1,
wherein, in step (b), said fluid is selected from a group consisting of water and a solution; said solution is added with a solute according to a requirement; and said solute is an agent adjusting the specific gravity of said fluid to 1.10˜1.19.

4. The method according to claim 3,
wherein said agent is selected from a group consisting of sodium hydroxide and sodium chloride.

5. The method according to claim 1,
wherein, in step (b), said fluid is fed into said outer column from said fluid inlet at bottom of said column body in a flow speed of 20˜45 cm per minute.

6. The method according to claim 1,
wherein, in step (c), said inner column is adjusted to a position 1˜2 cm above said layer of mixed resin.

7. The method according to claim 1,
wherein, in step (c), 80 percent of said anion exchange resin is separated from said cation exchange resin in a short time.

8. The method according to claim 1,
wherein said outer column has a volume of 1˜5 liters, an inner diameter of 2˜8 cm and a length of 65˜95 cm.

9. The method according to claim 1,
wherein a filter is further disposed at bottom of said outer column of said column body.
